(19) United States
(12) Patent Application Publication
(10) Pub. No.: US 2022/0118291 A1
(43) Pub. Date: Apr. 21, 2022

(54) DEVICES AND METHODS FOR CIRCULATING AIR BETWEEN A FACE COVERING AND AN INDIVIDUAL WEARING THE FACE COVERING

(71) Applicant: Galymjohn Kuras, River Grove, IL (US)

(72) Inventor: Galymjohn Kuras, River Grove, IL (US)

(21) Appl. No.: 17/502,449

(22) Filed: Oct. 15, 2021

Related U.S. Application Data
(60) Provisional application No. 63/092,745, filed on Oct. 16, 2020.

(51) Int. Cl. A62B 18/00; A62B 7/10; A62B 9/04; A62B 18/02; A62B 23/02

(52) U.S. Cl. CPC A62B 18/006; A62B 7/10; A62B 23/025; A62B 18/025; A62B 9/04

(57) ABSTRACT

Devices and methods for delivering and circulating air within an air pocket between a face covering and the face of an individual wearing the face covering. The device has an air inlet, an air outlet, and a passage therebetween that fluidically couples the air inlet and outlets, a filter configured to filter air passing through the passage between the air inlet and the air outlet, a fastener configured to releasably secure the device to the face covering such that the air inlet is located outside of the air pocket and exposed to atmospheric air and the air outlet is located within the air pocket, and an air transport system configured to force air from the atmospheric air to flow into the air inlet, through the filter, and out of the air outlet into the air pocket.

### CROSS REFERENCE TO RELATED APPLICATIONS

This application claims the benefit of U.S. Provisional Application No. 63/092,745, filed Oct. 16, 2020, the contents of which are incorporated herein by reference.

### BACKGROUND OF THE INVENTION

The present invention generally relates to the use of face coverings, including but not limited to face masks, filters, and shields used as personal protective equipment (PPE). The invention particularly relates to devices and methods for providing air circulation within an air pocket between a face covering and the face of an individual wearing the face covering.

The recent spread of contagious pathogens and increased awareness of the potential effectiveness of face coverings in reducing such spread has led to widespread increases in everyday public use of face coverings, which as used herein includes but is not limited to face masks, face filters, and face shields used as personal protective equipment (PPE). While use of face coverings appears to have a significant impact on the spread of certain diseases, this increase in use has led to other inconvenient side effects. For example, certain people have experienced labored breathing while wearing the face coverings due to reduced oxygen levels, increased carbon dioxide levels, and increased temperatures of intake air. These side effects can be particularly distressing for people performing vigorous physical activities such as sports or exercise, and people located in crowded, poorly ventilated locations such as public transportation vehicles. This has been associated not only with a decrease in general comfort while wearing the face coverings, but also with a change in consumer behavior that has contributed to a decline in revenue for certain businesses such as gyms.

In view of the above, it would be desirable if devices or methods were available for enhancing the experience of wearing face coverings that were capable of at least partly overcoming or avoiding these problems, shortcomings or disadvantages.

### BRIEF DESCRIPTION OF THE INVENTION

The present invention provides devices and methods capable of delivering and circulating air in an air pocket defined between a face covering and a face of an individual wearing the face covering.

According to one aspect of the invention, a device is provided that is configured to be coupled to and used with a face covering while the face covering is worn by an individual such that portions of the face covering cover the nose and/or mouth of the individual and define an air pocket between the portions of the face covering and the face of the individual. The device includes an air inlet, an air outlet, and a passage therebetween that fluidically couples the air inlet and the air outlet, a filter configured to filter air passing through the passage between the air inlet and the air outlet, a fastener configured to releasably secure the device to the face covering such that the air inlet is located outside of the air pocket and exposed to atmospheric air and the air outlet is located within the air pocket, and an air transport system configured to force air from the atmospheric air to flow into the air inlet, through the filter, and out of the air outlet into the air pocket.

According to another aspect of the invention, a method is provided for delivering and circulating air in an air pocket defined between portions of a face covering and a face of an individual wearing the face covering. The method includes securing a device to the face covering such that an air inlet of the device is located outside of the air pocket and exposed to atmospheric air and an air outlet of the device is located inside the air pocket, and operating an air transport system of the device to force air from the atmospheric air to flow into the air inlet, through a filter of the device, and out of the air outlet and into the air pocket.

Technical effects of the device and method described above preferably include the ability to enhance the comfort of an individual wearing a face covering by enhancing the circulation of air within an air pocket defined between the face covering and the individual's face.

Other aspects and advantages of this invention will be appreciated from the following detailed description.

### BRIEF DESCRIPTION OF THE DRAWINGS

FIG. 1 represents a perspective view of a first embodiment of a device in accordance with certain nonlimiting aspects of the invention.

FIG. 2 represents an exploded view of components of the device of FIG. 1.

FIG. 3 represents a side view of the device of FIG. 1.

FIG. 4 represents an isolated, perspective view of a second portion of the device of FIG. 1.

FIGS. 5 and 6 represent the device of FIG. 1 secured to a face covering worn by an individual.

FIG. 7 represents a partially exploded, perspective view of a second embodiment of a device in accordance with certain nonlimiting aspects of the invention.

FIG. 8 represents a front view of the device of FIG. 7 disassembled to show internal components thereof.

FIG. 9 represents a partially exploded, perspective view of the device of FIG. 7 illustrating a method of assembling a filter assembly thereof.

FIG. 10 represents a cross-sectional view of the device of FIG. 7.

FIGS. 11 and 12 represent the device of FIG. 7 secured to a face covering worn by an individual.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of what is depicted in the drawings, including the embodiment(s) depicted in the drawings. The following detailed description also identifies certain but not all alternatives of the embodiment(s) depicted in the drawings. Therefore, the appended claims, and not the detailed description, are intended to particularly point out subject matter regarded as the invention, including certain but not necessarily all of the aspects and alternatives described in the detailed description.

Disclosed herein are devices and methods intended to enhance the comfort of individuals while wearing face coverings, including but not limited to face masks, filters, and shields used as personal protective equipment (PPE), by enhancing the circulation of air within an air pocket between the face covering and an individual wearing the face covering. As a particular but nonlimiting example, such devices and methods can be used in combination with a face covering that covers the nose and/or mouth of an individual to create an air pocket between the face covering and a portion of the individual's face, and can deliver air to the air pocket from atmospheric air surrounding the individual to both ventilate the air pocket and circulate air within the air pocket. The device may be used with various types of face coverings, including those that are air permeable or have an air-permeable region, cover at least the nose and/or mouth of an individual, filter air that passes through the face coverings or an air-permeable region thereof as a result of an individual's natural breathing, and create an air pocket that surrounds the nose and/or mouth of the individual. Exemplary face coverings may include but are not limited to surgical masks (e.g., 3-ply, 4-ply, 5-ply), single and multilayer cloth masks, and respiratory masks (e.g., N95, KN95, FFP2).

In the following description, as a matter of convenience nonlimiting embodiments of the device are described in relation to face coverings that are adapted to cover both the nose and mouth of an individual (also referred to herein as a wearer), is air permeable such that the natural breathing of the wearer is able to draw air through the body, has a top edge that traverses the nose of the wearer, has a bottom edge that traverses the chin of the wearer, has side edges that extend between the top and bottom edges of the body, and is secured to the wearer with one or more pair of loops, as an example, a pair of loops that wrap around the ears of the wearer. In this configuration, the top edge of the body of the face covering can be described as extending between upper connection points of the loops and the bottom edge of the body can be described as extending between lower connection points of the loops.

In general, the device is configured to be secured to a face covering during use thereof and deliver atmospheric air to the air pocket created by the face covering, with the result that the air pocket can be ventilated and the air within the air pocket can be circulated. Such configurations may promote comfort of the wearer by, for example, reducing humidity within the air pocket, increasing oxygen content within the air pocket, and reducing carbon dioxide content of the air within the air pocket. To help maintain the ability of the face covering to reduce the spread of certain diseases, the device preferably includes a filter capable of trapping contagious pathogens entrained in the air delivered by the device to the air pocket.

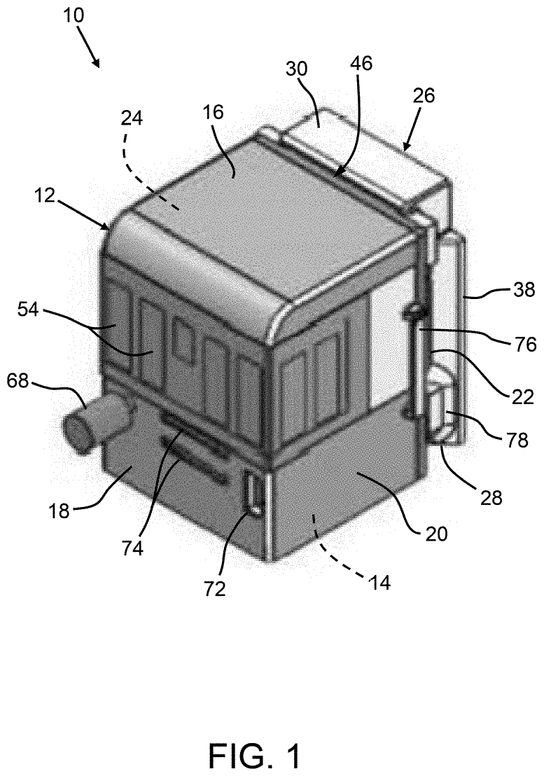

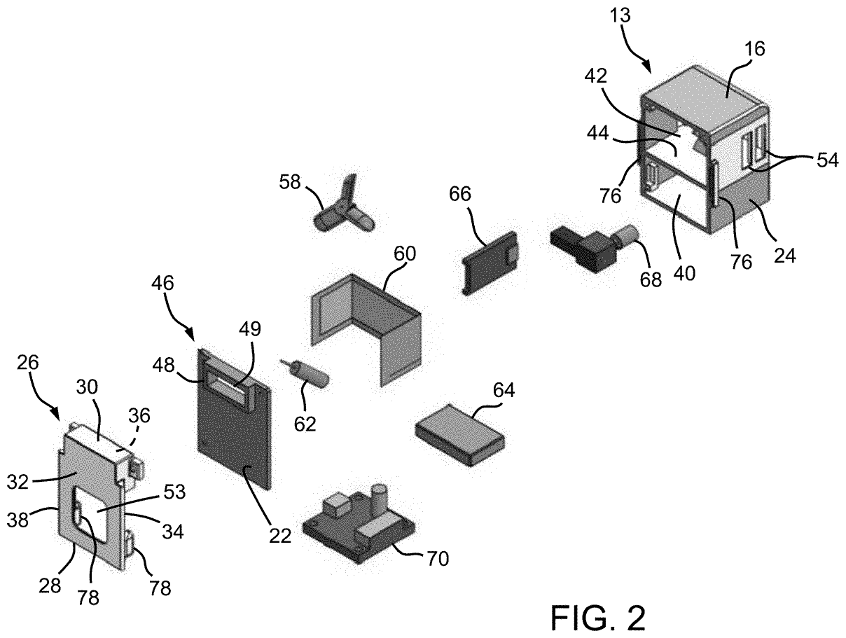

FIGS. 1 through 6 represent a nonlimiting first embodiment of the device 10. The device 10 includes a primary portion 12 and a secondary portion 26. The nonlimiting embodiment of the primary portion 12 depicted in FIGS. 1 through 6 is represented as having a generally rectangular cuboid shape, and therefore can be described as having a first (bottom) end 14, a second (top) end 16, and first, second, third, and fourth sides 18, 20, 22, and 24 therebetween. The third side 22 of the primary portion 12 is defined by a cover panel 46 that is releasably secured to the remainder of the primary portion 12, which can generally be described as a housing 13 (FIG. 2) comprising the first and second ends 14 and 16 and the first, second, and fourth sides 18, 20, and 24 of the primary portion 12. FIG. 2 shows first and second compartments 40 and 42 that are defined within the housing 13 and separated by an intermediate wall 44 located between the first and second ends 14 and 16. The cover panel 46 that defines the third side 22 of the primary portion 12 encloses the compartments 40 and 42 within the housing 13. While the housing 13 and the cover panel 46 of the primary portion 12 are each represented as being a unitary component, it is foreseeable that either or both could be an assembly of subcomponents.

The nonlimiting embodiment of the secondary portion 26 depicted in FIGS. 1 through 6 can also be described as having a first (bottom) end 28, a second (top) end 30, and first, second, third, and fourth sides 32, 34, 36, and 38 therebetween. A receptacle 52 (FIG. 4) is disposed on the third side 36 of the secondary portion 26 adjacent the second end 30, and a pair of protuberances 78 are disposed on the third side 36 of the secondary portion 26 adjacent the first end 28. While the secondary portion 26 is represented as being a unitary component, it is foreseeable that the secondary portion 26 could be an assembly of subcomponents.

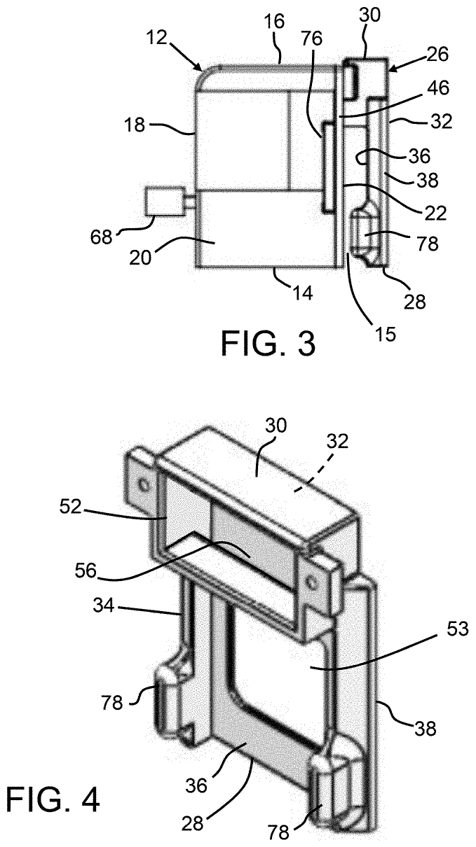

As more readily apparent from FIG. 3, the primary and secondary portions 12 and 26 are coupled to each other at their respective third sides 22 and 36 adjacent their respective second ends 16 and 30, and are otherwise spaced apart from each other to define a gap or slot 15 therebetween. FIG. 2 represents the third side 22 (defined by the cover panel 46) of the primary portion 12 as including a protruding duct 48 that defines and surrounds a passage 49 therethrough. When the cover panel 46 is coupled to the housing 13 of the primary portion 12, the passage 49 is fluidically coupled to the second compartment 42 within the housing 13. When the primary and secondary portions 12 and 26 are coupled to each other, the protruding duct 48 of the primary portion 12 is received within the receptacle 52 of the secondary portion 26, so that the passage 49 of the duct 48 fluidically couples the second compartment 42 of the primary portion 12 with the receptacle 52 of the secondary portion 26. The duct 48 is preferably secured within the receptacle 52 so that the duct 48 and receptacle 52 effectively serve as a coupling between the primary and secondary portions 12 and 26 adjacent their respective second ends 16 and 30

The first, second, and fourth sides 18, 20, and 24 of the primary portion 12 include openings that define air inlets 54 to provide access for air to enter the second compartment 42 of the primary portion 12. The receptacle 52 defines an air outlet 56 that directs air received from the duct 48 of the primary portion 12 into the slot 15 between the primary and secondary portions 12 and 26 and toward a vent 53 in the secondary portion 26. As such, the air inlets 54 of the primary portion 12 are fluidically coupled with the air outlet 56 of the secondary portion 26 through the second compartment 42 of the primary portion 12, through the passage 49 in the protruding duct 48 of the primary portion 12, and through the receptacle 52 of the secondary portion 26.

The first and second compartments 40 and 42 store therein components of an air transport system configured to force air from the atmospheric air surrounding the housing 13 to flow through the air inlets 54 into the second compartment 42 and through a filter 60 within the second compartment 42, after which the resulting filtered air exits the device 10 through the outlet 56 as described above. The device 10 is configured so that the slot 15 between the primary and secondary portions 12 and 26 and the vent 53 in the secondary portion 26 can be disposed in an air pocket formed by a face covering on which the device 10 is installed (described in further detail below) such that air drawn by the air transport system through the primary and secondary portions 12 and 26 is forced into the air pocket of the face covering.

As represented in FIG. 2, the air transport system comprises a fan 58 located within the second compartment 42 for drawing air into the second compartment 42 through the air inlets 54 and filter 60 and toward the passage 49 of the duct 48. FIG. 2 schematically represents the filter 60 as a sheet having three sections oriented relative to one another to cover all of the air inlets 54 in the sides 18, 20, and 24 of the housing 13. The air transport system further comprises a motor 62 for driving the fan 58 within the second compartment 42, a battery 64 configured to power the motor 62, a charge chip 66 configured to receive power from an external source via a charging cable and recharge the battery 64 with the received power, and a control knob or switch 68 and corresponding circuit board 70 configured to control the motor 62 and thereby control the rotational speed of the fan 58. The first compartment 40 is preferably sized and configured to accommodate and enclose the motor 62, battery 64, charge chip 66, and circuit board 70. The control switch 68 is exposed on the exterior of the primary portion 12 at its first side 18 so as to be accessible to a user of the device 10. A port 72 is represented as also disposed at the first side 18 of the primary portion 12 to allow for coupling a charging cable to the charge chip 66. Preferably, the first and second compartments 40 and 42 are fluidically separated by the intermediate wall 44 such that air flowing through the second compartment 42 and passage 49 between the air inlets 54 and outlet 56 is not forced into the first compartment 40 and air warmed by heat produced by the components of the air transport system within the first compartment 40 does not flow into the second compartment 42. Instead, warm air within the first compartment 40 is preferably expelled through vents 74 that also allow cooling air to enter the first compartment 40 and thereby cool the components therein.

The nonlimiting device 10 depicted in FIGS. 1 through 6 is represented as comprising a pair of strap loops 76 on the second and fourth sides 20 and 24 of the primary portion 12. A strap (not shown) may be secured between these strap loops 76 and wrapped around a wearer's head to assist in retaining the device 10 in position relative to the face covering worn by the wearer. This may be particularly beneficial when the wearer is participating in relatively vigorous physical activities such as sports and/or exercise.

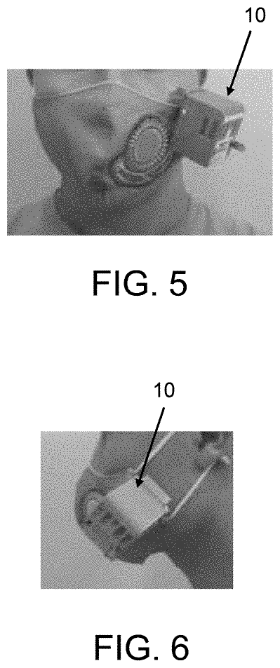

FIGS. 5 and 6 represent the device 10 as releasably secured to a top edge and a side edge, respectfully, of a face covering on a wearer. As represented, the device 10 is configured to be secured to the face covering by inserting an edge of the face covering into the slot 15 defined by and between the primary and secondary portions 12 and 26. The slot 15 is open at the first ends 14 and 28 of the primary and secondary portions 12 and 26, as well as open along sides 20, 24, 34, and 38 of the primary and secondary portions 12 and 26, but closed at the coupling between the primary and secondary portions 12 and 26 at their respective second ends 16 and 30. Upon receiving the edge of the face covering within the slot 15, the primary portion 12 is on the outside of the face covering and that part of the secondary portion 26 below the receptacle 52 and containing the air outlet 56 is within the air pocket formed between the face covering and the face of the wearer. Preferably, the sides 22 and 36 of the primary and second portions 12 and 26 defining the slot 15 define and act as a fastener to secure the edge of the face covering within the slot 15. The pair of protuberances 78 extending from the third side 36 of the secondary portion 26 may pinch the face covering to improve the grip thereon.

In the nonlimiting arrangement represented in FIGS. 1 through 6, the air inlets 54 are located opposite the slot 15 and therefore outside of the air pocket so as to be exposed to atmospheric air surrounding the primary portion 12, and the air outlet 56 is located within the air pocket. Upon activation of the air transport system, the fan 58 operates to draw air through the air inlets 54, through the filter 60, through the second compartment 42, through the passage 49, into the receptacle 52, and out the air outlet 56. As such, air from the surrounding environment is filtered before being forced into the air pocket at a rate defined by the operating speed of the motor 62 and controllable with the control switch 68.

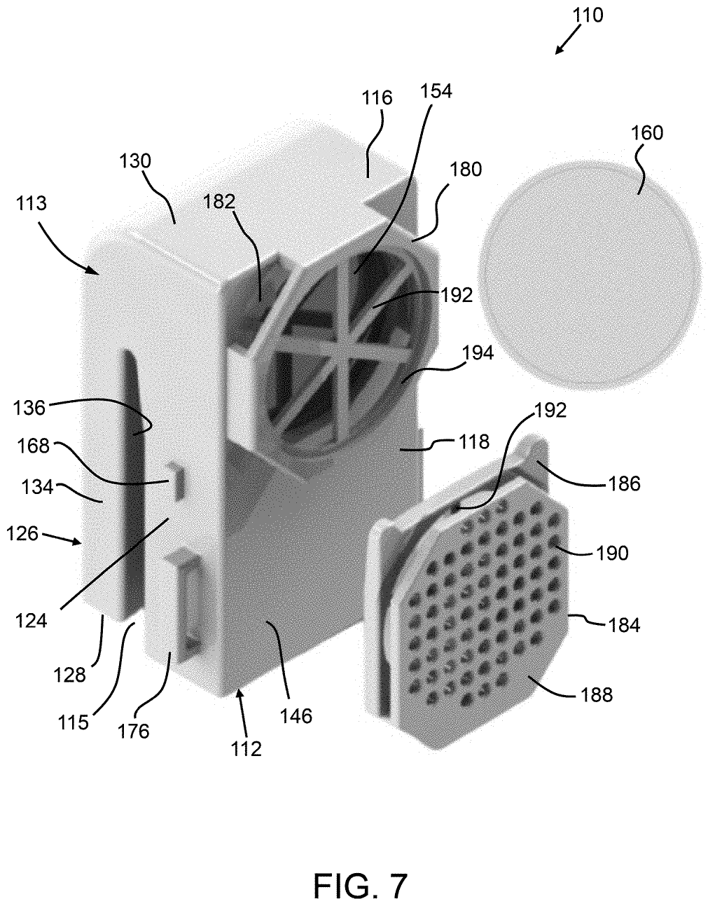

FIGS. 7 through 12 represent a nonlimiting second embodiment of a device 110. In these figures, consistent reference numbers are used to identify the same or functionally equivalent elements, but with a numerical prefix (1) added to distinguish the particular embodiment from the embodiment of FIGS. 1 through 6. In view of similarities between the first and second embodiments, the following discussion of the second embodiment will focus primarily on aspects of the second embodiment that differ from the first embodiment in some notable or significant manner. Other aspects of the second embodiment not discussed in any detail can be, in terms of structure, function, materials, etc., essentially as was described for the first embodiment.

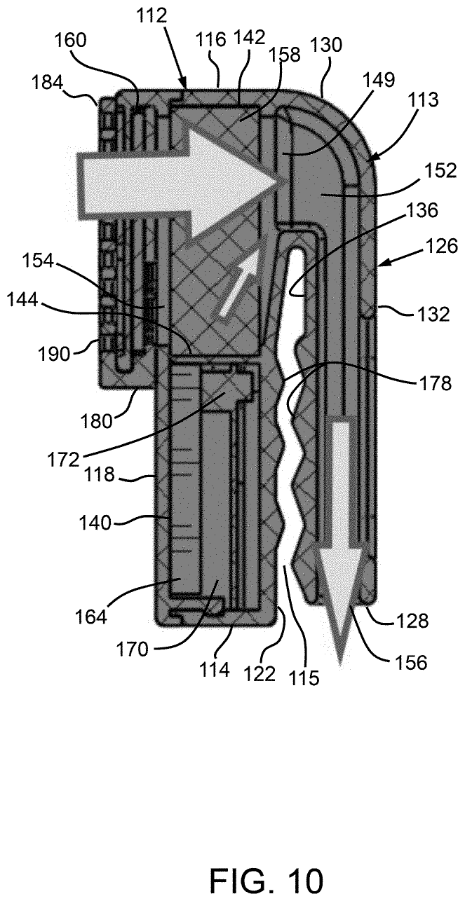

Similar to the device 10 of FIGS. 1 through 6, the embodiment of FIGS. 7 through 12 comprises a primary portion 112 and a secondary portion 126, which define a slot 115 therebetween. In contrast to the device 10 whose primary and secondary portions 12 and 26 are separate members that are assembled to each other, the primary and secondary portions 112 and 126 are not separate members and instead are integral portions of a unitary housing 113 and adjoin each other in a portion of the housing 113 that contains a passage 149 (FIG. 10) fluidically coupling an air inlet 115 of the device 110 to an air outlet 154 of the device 110. As a result of the slot 115 between the primary and secondary portions 112 and 126, the unitary housing 113 can be seen in FIGS. 7 and 10 to have a generally U-shaped configuration, wherein the portion of the housing 113 that contains the passage 149 defines a base of the U-shape and the primary and secondary portions 112 and 126 define the legs of the U-shape. In both embodiments, the primary portions 12 and 112 are intended to store internal components of an air transport system and the secondary portions 26 and 126 are intended to be located beneath a face covering and direct air flow into an air pocket defined by the face covering. Both embodiments also include a cover panel 46 and 146 intended to enclose the internal components within the primary portion 12 and 112.

Similar to the first embodiment, the primary portion 112 includes a first end 114, a second end 116, first, second, third, and fourth sides 118, 120, 122, and 124, and first and second compartments 140 and 142 that are separated by an intermediate wall 144. Also similar to the first embodiment, the secondary portion 126 includes a first end 128, a second end 130, and first, second, third, and fourth sides 132, 134, 136, and 138. Access to components within the housing 113 is provided through the cover panel 146 secured to the primary portion 112 and defining the first side 118 thereof. As seen in FIG. 10, the air inlet 154 is defined in the cover panel 146 at the second end 116 of the primary portion 112, and the air outlet 156 is defined at the first end 128 of the secondary portion 126.

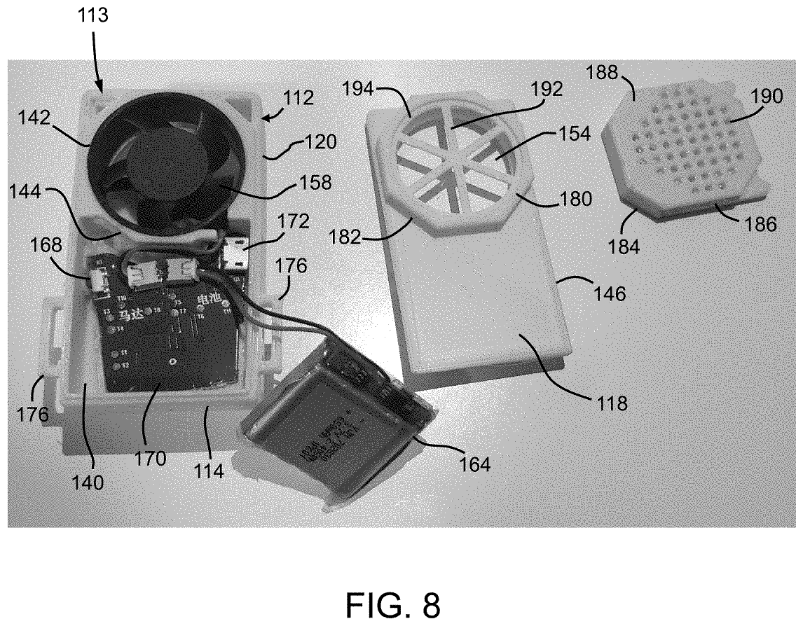

FIG. 8 represents the device 110 disassembled to show the components within the first and second compartments 140 and 142 of the primary portion 112. The first compartment 140 includes a battery 164, a control switch 168, and a switch circuit board 170. A portion of the switch 168 is exposed on an exterior side of the fourth side 124 of the primary portion 112. The second side 120 of the primary portion 112 includes a port 172 for coupling a charging cable to recharge the battery 164. The second compartment 142 includes a fan 158 having an internal motor (not shown).

The device 110 includes a filter assembly upstream of the fan 158 that is configured to removably secure a filter 160 over the air inlet 154 to the second compartment 142. The filter assembly includes a bracket 180 fixed to the cover panel 146 having a protruding wall that circumferentially surrounds the air inlet 154. The bracket 180 includes slots 182 on opposite sides thereof configured to slidably receive and frictionally retain a corresponding fastener portion 186 of a filter cover 184. The fastener portion 186 is coupled to an exterior member 188 such that a slot is defined therebetween that is configured to receive the protruding wall of the bracket 180. The filter cover 184 includes a plurality of holes 190 to allow air to pass therethrough.

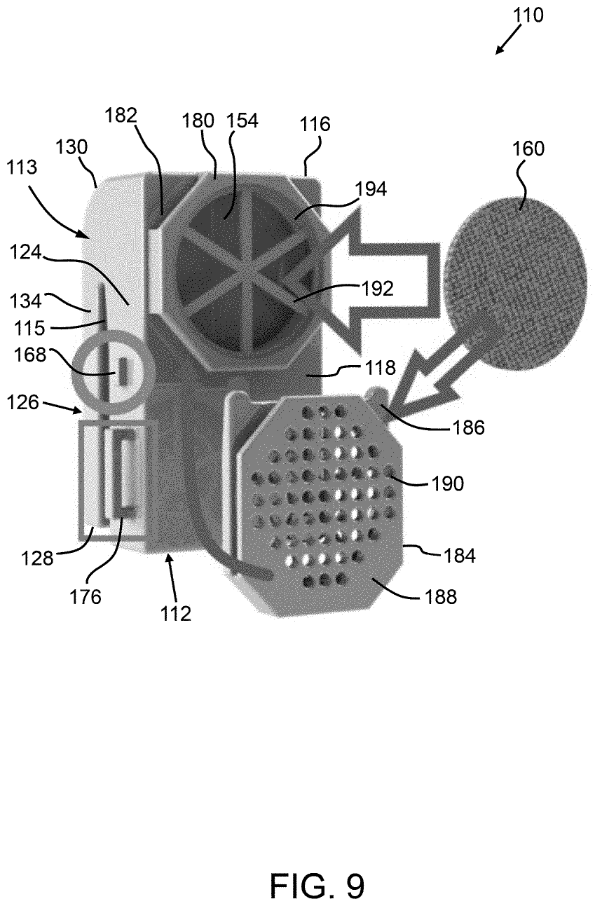

Cross brace members 192 extend across diameters of the air inlet 154 within the protruding wall of the bracket 180 and the fastener portion 186 of the filter cover 184. When the filter cover 184 is mated with the bracket 180 to cover the air inlet 154, a compartment is defined between interior surfaces of the protruding wall of the bracket 180, the cross brace members 192 of the bracket 180, and the cross brace members 192 of the filter cover 184 that is configured to receive and store the filter 160. Preferably, the bracket 180 includes a rim 194 extending from interior surfaces of the protruding wall that is configured to contact the filter 160 and thereby provide a seal around a perimeter of the filter 160 such that all air passing through the filter assembly passes through the filter 160 prior to entering the air inlet 154. FIG. 9 schematically represents a method of assembling the filter assembly with arrows indicating locations of the filter 160 and the filter cover 184.

The filter assembly of the second embodiment may promote ease of replacement of the filter 160 relative to the interior filter 60 of the first embodiment. In particular, the filter 160 of the second embodiment may be replaced without the use of tools and replacement of the filter 160 does not expose internal components of the housing 113 such as the electrical components of the air transport system.

As represented in FIG. 10, the passage 149 fluidically couples the second compartment 142 of the primary portion 112 with a receptacle 152 located within the secondary portion 126, which in turn is fluidically connected to the air outlet 156 at the first end 128 of the secondary portion 126. This arrangement may improve air flow into an air pocket by reducing restrictions to air flow. Air flow through the device 110 is represented with arrows in FIG. 10.

Instead of the pair of protuberances 78 on the third side 36 of the secondary portion 26 of the first embodiment, the second embodiment includes an array of opposing protuberances 178 within the slot 115 that are disposed on the third side 122 of the primary portion 112 and on the third side 136 of the secondary portion 126. Optionally, these arrays of protuberances 178 may include oppositely disposed peaks and valleys, as represented in FIG. 10, that in combination are configured to provide a series of pressure points on portions of a face covering located within the slot 115 to define and act as a fastener to secure the edge of the face covering within the slot 115.

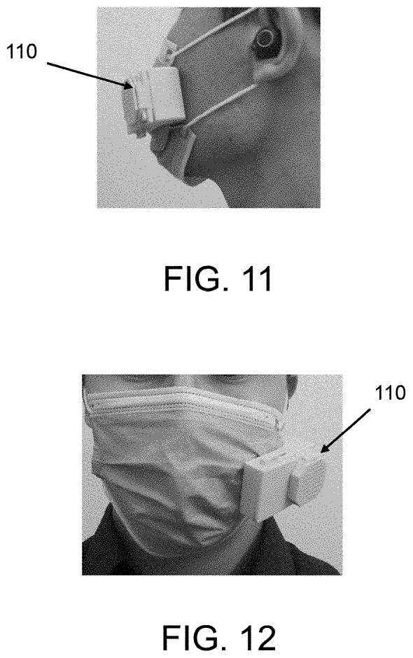

FIGS. 11 and 12 represent the device 110 as releasably secured to a side edge of a face covering on a wearer. As with the first embodiment, the device 110 is configured to be secured to the face covering by inserting an edge of the face covering into the slot 115 defined by and between the third side 122 of the primary portion 112 and the third side 136 of the secondary portion 126. The slot 115 is open at the first ends 114 and 128 of the primary and secondary portions 112 and 126, as well as open along sides 120, 124, 134, and 138 of the primary and secondary portions 112 and 126, but closed where the primary and secondary portions 112 and 126 are adjoined at their respective second ends 116 and 130. Upon receiving the edge of the face covering within the slot 115, the primary portion 112 is on the outside of the face covering and that part of the secondary portion 126 below the receptacle 152 and containing the air outlet 156 is within the air pocket formed between the face covering and the face of the wearer.

The devices 10 and 110 provide methods of providing a flow of filtered air to the air pocket defined between a face covering and a wearer of the face covering. The method may include securing the device 10/110 to the face covering such that the air inlet(s) 54/154 of the device 10/110 is located outside of the air pocket and exposed to atmospheric air and the air outlet 56/156 of the device 10/110 is located inside the air pocket formed between the face covering and the face of the wearer. Once in this arrangement, the air transport system of the device 10/110 may be operated to draw air from the surrounding atmosphere to flow into the air inlet(s) 54/154, and then force the air through the filter 60/160 and out through the air outlet(s) 56/156 and into the air pocket.

Securing the device 10/110 to the face covering may include sliding the edge of the face covering and portions of the face covering adjacent thereto into the slot 15/115 defined between the third side 22 of the primary portion 12 and the third side 36 of the second portion 26 of the device 10 or between the third side 122 of the primary portion 112 and the third side 136 of the secondary portion 126 of the device 110 such that the primary portion 12 or 112 is on the outside of the face covering and the secondary portion 26 or 126 is within the air pocket.

Optionally, the wearer may operate the controls of the device 10/110 to selectively operate the fan 58/158 of the air transport system at one of two or more rotational speed settings to control the flow rate of the air through the device 10/110.

The battery 64/164 may be recharged by coupling a charging cable to the port 72/172 of the device 10/110 and providing electrical power through the charging cable from the external power source. Preferably, the filter 60/160 of the device 10/110 may be replaced periodically or as necessary.

While the invention has been described in terms of specific embodiments, it is apparent that other forms could be adopted by one skilled in the art. For example, the physical configuration of the devices 10 and 110 could differ from those shown, various clips, hook-and-loop fasteners, etc., could be utilized in place of or in addition to the slots 15 and 115 and protuberances 78 and 178 to secure the devices 10 and 110 to a face covering, and materials and processes/methods other than those noted could be used to manufacture the devices 10 and 110 and their components. In addition, the invention encompasses additional embodiments in which one or more features or aspects of different disclosed embodiments may be combined. Therefore, the scope of the invention is to be limited only by the following claims.

1. A device configured to be coupled to and used with a face covering while the face covering is worn by an individual such that portions of the face covering cover the nose and/or mouth of the individual and define an air pocket between the portions of the face covering and the face of the individual, the device comprising:
primary and secondary portions that in combination comprise an air inlet, an air outlet, and a passage therebetween that fluidically couples the air inlet and the air outlet;
a filter configured to filter air passing through the passage between the air inlet and the air outlet;
a fastener configured to releasably secure the device to the face covering such that the air inlet is located outside of the air pocket and exposed to atmospheric air and the air outlet is located within the air pocket; and
an air transport system configured to force air from the atmospheric air to flow into the air inlet, through the filter, and out of the air outlet into the air pocket.

2. The device of claim 1, wherein the filter and the air transport system are disposed within the primary portion.

3. The device of claim 1, wherein the fastener comprises a slot defined by and between the primary and secondary portions, and the slot is configured to receive an edge of the face covering such that the primary portion is on the outside of the face covering and the secondary portion is within the pocket formed between the face covering and the face of the individual.

4. The device of claim 1, wherein the primary portion comprises the air inlet and the secondary portion comprises the air outlet.

5. The device of claim 4, wherein the primary and secondary portions have adjacent first ends and adjacent second ends, the air outlet is at the first end of the secondary portion and the filter is at the second end of the primary portion.

6. The device of claim 1, wherein the air transport system comprises a fan that is configured to draw air through the air inlet and force the air through the passage and out the air outlet.

7. The device of claim 1, wherein the primary portion comprises a first internal compartment that is fluidically separate from the passage between the air inlet and the air outlet, and the internal compartment contains components of the air transport system.

8. The device of claim 7, wherein the primary portion comprises a second internal compartment that is fluidically connected to the passage between the air inlet and the air outlet, and the fan is disposed in the internal compartment.

9. The device of claim 7, wherein the components of the air transport system comprise a motor configured to rotate the fan and a battery configured to power the motor.

10. The device of claim 9, wherein the battery is rechargeable and the device comprises a port configured for receiving a plug of a charging cable and receiving electrical power therethrough from an external power source, the device comprising one or more electrical components configured for recharging the battery with the electrical power received through the port from the external power source.

11. The device of claim 1, wherein the primary and secondary portions are not separate members and instead are integral portions of a unitary housing.

12. The device of claim 1, wherein the primary portion comprises a removable cover panel and the air inlet and the filter is disposed in the removable cover panel.

13. A method of delivering and circulating air in an air pocket defined between portions of a face covering and a face of an individual wearing the face covering, wherein a nose and a mouth of the individual are within the air pocket, the method comprising:
securing a device to the face covering such that an air inlet of the device is located outside of the air pocket and exposed to atmospheric air and an air outlet of the device is located inside the air pocket; and
operating an air transport system of the device to force air from the atmospheric air to flow into the air inlet, through a filter of the device, and out of the air outlet and into the air pocket.

14. The method of claim 13, further comprising replacing the filter of the device.

15. The method of claim 13, wherein securing the device to the face covering comprises sliding an edge of the face covering and portions of the face covering adjacent thereto into a slot defined by and between primary and secondary portions of the device such that the primary portion is on the outside of the face covering and the secondary portion is within the air pocket, wherein walls of the primary and second portions defining the slot define a fastener configured to retain the device on the face covering.

16. The method of claim 13, wherein operating the air transport system comprises operating a fan to blow air through a passage of the device that fluidically couples the air inlet to the air outlet.

17. The method of claim 16, further comprising operating controls of the device to selectively rotate the fan at one of two or more rotational speed settings.

18. The method of claim 16, wherein the air transport system comprises a motor configured to rotate the fan and a battery configured to power the motor, the method further comprising recharging the battery by coupling a charging cable to a port of the device and providing electrical power through the charging cable from an external power source.

19. The method of claim 13, wherein the portions of the face covering are permeable to air and configured to filter air passing therethrough.

20. The method of claim 13, wherein the face covering is a surgical mask, a cloth mask, or a respiratory mask.
